(19) United States
(12) Patent Application Publication
(10) Pub. No.: US 2008/0124697 A1
(43) Pub. Date: May 29, 2008

(54) System and method for live teaching of casino games

(76) Inventors: Catelyn Pacchioli, Henderson, NV (US); Margaret Mary Cadena, Henderson, NV (US)

Correspondence Address: WEIDE & MILLER, LTD., 7251 W. LAKE MEAD BLVD., SUITE 530, LAS VEGAS, NV, 89128, US

(21) Appl. No.: 11/588,956

(22) Filed: Oct. 27, 2006

(51) Int. Cl. G09B 3/00

(52) U.S. Cl. 434/350

(57) ABSTRACT

In a casino game instruction system, a student accesses a host from a remote student location, such as a remote computer. The student is linked to an instructor at an instructor location, such as via a communication link over the world wide web. A live casino game demonstration including instructions regarding game play, is presented to the student. Audible instructions are forwarded from the instructor to the student. Visible game demonstration information and other instruction information is displayed via a virtual classroom. The student may provide game simulation inputs and ask questions. In a multi-student environment, students may communicate with the instructor privately or publicly, and students may communicate with one another.

### TECHNICAL FIELD

This invention relates generally to the gaming industry, and more specifically, to a system and method for teaching casino-type games.

### BACKGROUND OF THE INVENTION

Play of wagering games is becoming an ever increasingly popular activity. In recent years, wager based gaming has expanded to include not only table games such as poker, blackjack, pai gow and others, but mechanical slot machines and a variety of electronic games such as video poker. In addition, gaming has expanded geographically.

In the past, table-based gaming was the domain of a relatively narrow cross-section of the public. Today, many more people wish to play table-based games. In some cases, persons who were not previously exposed to wager-based gaming found that activity available, such as due to convenience of travel to locations such as Atlantic City and Las Vegas. In other cases, persons who enjoyed wagering by playing video poker and similar machines became interested in playing table games.

Frequently, people who have an interest in playing table games lack the knowledge and confidence to play such game. In particular, inexperienced players are often intimidated and avoid table games. In some cases, the player may not understand the basic rules of the game. In others, the player may not understand the “protocol” involved in playing a table game.

Some players will attempt to learn the rules and protocol of play by reading books about the game or by standing behind other players who are playing an actual game. Both of these methods, however, are relatively ineffective in actually teaching the player how to play. Reading a book, the player does not learn the table protocol. Watching a game, the player is not provided any instructions, so must “learn” without direct reference to the rules. In either event, the player may still be ill-prepared to conduct themselves in the play of a table game.

### SUMMARY OF THE INVENTION

The present invention comprises a system and method for providing casino game instructions wherein an instructor interacts with one or more remotely located students in real time.

One embodiment of the invention is a system for teaching casino game play, and particularly, for providing casino table game demonstrations and instructions. In one embodiment of a system, at least one student and a remotely located instructor are linked by communication link. In a preferred embodiment, a first communication link is established between a student location, such as a remote computer, and a host. A second communication link is established between the host and an instructor location. The student might access the host, for example, by using a web browser to access a web site supported by the host, and accessible over the world wide web.

In one embodiment, the host is configured to generate virtual classroom information. The classroom includes graphical information, such as an image of a casino table. Audible and/or textual instructions are transmitted from the instructor to the student. Preferably, the instructor may provide input which causes the host to generate graphical information which is displayed to the student and instructor, such as images of one or more cards.

The student may transmit textual or audible information to the instructor. In one embodiment, the student may transmit such information privately, in which case such information is only provided to the instructor. The student may also transmit such information publicly, in which case the host may forward the information to other students.

In other embodiments, instead of graphical information, the host may be configured to transmit live video. For example, the host may be configured to forward live video obtained at either the student or instructor location to the other party(ies).

In one embodiment, the game instruction is arranged as a class. A plurality of students form communication links with the host for interaction with an instructor(s).

In one embodiment, the system host includes one or more modules. These modules may include a student module, a player module, and an administrator module. These modules may implement various functionality. Such functionality may include student registration, payment for services (such as one or more classes), instructor registration, and setting of fees and rates, class times and the like.

In accordance with a method of the invention, a student (such as a potential casino table game player) receives live casino game play instruction or tutelage. This instruction may comprise visual information regarding play of a casino game, such as a visual representation or demonstration of a of casino game. This may include visual information regarding the casino game setting, such as the appearance of a casino game table. In addition, the student receives live game play instructions concurrently with the demonstration as part of the instructional event. Such instructions may comprise information pertaining to the various steps of game play. The student may also ask questions and have them answered by the instructor as the instructional event occurs.

Advantageously, the invention permits a student to learn a casino game without having to play the game in a live casino environment. Thus, the student is not required to risk wagers and is not bound by game rules. However, the student is trained in “virtual” format, meaning that the casino game environment is emulated.

Other advantages of the present invention will become apparent to those skilled in this art from the description wherein there is shown and described an embodiment of this invention, simply by way of illustration of the modes best suited to carry out the invention. As will be realized, the invention is capable of other different embodiments and its several details are capable of modification in various, obvious aspects all without departing from the invention. Accordingly, the drawings and descriptions will be regarded as illustrative in nature and not as restrictive.

### DESCRIPTION OF THE DRAWINGS

The accompanying drawings incorporated in and forming a part of this specification illustrates several aspects of the present invention and together with the description severs to explain the principles of the invention. In the drawings:

FIG. 1 is a block diagram of an example embodiment of the casino game instruction system of the present invention;

FIG. 2 is a schematic diagram of a table game for which instruction may be provided in accordance with the operation of the present invention; and

FIG. 3 is an operational flow diagram of an exemplary method of operation of the present invention.

Reference will now be made in detail to various embodiments of the invention, an example of which is illustrated in the accompanying drawings.

### DETAILED DESCRIPTION OF THE INVENTION

In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

One aspect of the invention is a method of teaching one or more players a casino game. Another aspect of the invention is a system for implementing a method of the invention.

In a preferred embodiment, the invention is a method of permitting a remotely located student/player to interact with a live dealer/instructor, whereby the teaching involves presentation of one or more games without a wager and with instructions or information regarding play of the game. In a preferred embodiment, the system comprises one or more host devices for transmitting game play information regarding a live, non-wagering event including an instructor, to one or more students.

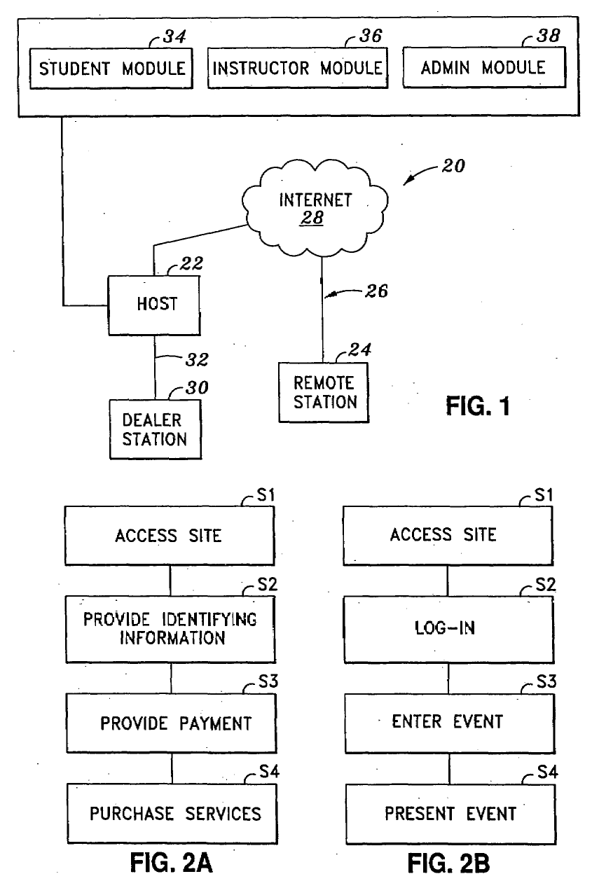

FIG. 1 illustrates one embodiment of a system 20 of the invention. It will be appreciated that the system 20 is but one embodiment of an environment in or by which the methods of the invention may be implemented. As illustrated, the system 20 preferably comprises at least one host 22. In one embodiment, the host 22 comprises one or more computing devices. Preferably, the host 22 includes one or more communication ports or connections and at least one data storage or “memory” device. The host 22 may comprise, for example, a server having a processor, operating system, communication ports, mass storage device(s) and various input/output devices. It will be appreciated, however, that the host 22 may have a variety of configurations. For example, the host 22 may be configured to communicate with an associated mass storage device rather than an “integrated” device.

The host 22 preferably includes hardware or software (computer readable program code for execution by a processor) for implementing various functionality. In one embodiment, the host 22 is configured to implement various student functions, various instructor functions and various administrator functions. The host 22 is also configured to transmit live game information and game instruction information to one or more students, and is configured to transmit student inquiries to instructors.

Still referring to FIG. 1, a student may communicate with the host 22 from a remote station 24 via a communication link 26. The remote station 24 may comprise, for example, a desk-top or lap-top computer or other device which preferably includes a user input (such as a keyboard, touch-screen or the like), a communication port, and a display device. In a preferred embodiment, the remote station 24 includes audio input and output devices, such as a microphone and speakers. In one embodiment, the remote station 24 may comprise a computing device having a web browser, such as Internet Explorer or Netscape Navigator, which browser is, at a minimum, capable of displaying information transmitted over the world wide web.

The communication link 26 is configured to transmit information between the remote station 24 and the host device 22. The communication link 26 may be wired and/or wireless. The communication link 26 may be dedicated and/or shared. For example, the communication link 26 could be a tele-communication link established directly between the remote station 24 and the host device 22. In a preferred embodiment, the communication link 26 comprises the world wide web or Internet 28. For example, a student may access the Internet using the remote station 24 and the associated browser and communication port thereto. The host device 22 may support one or more addresses on the Internet. It will be appreciated that multiple students may access the host 22, such as from independent stations 24 and associated communication links 26.

The system 20 preferably also includes one or more dealer or instructor stations 30. The instructor station 30 may comprise a physical location at which an instructor may present a casino-type game. For example, the instructor station 30 may comprise a gaming table. In a preferred embodiment, the instructor station 30 comprises a computing device. The instructor station 30 may comprise, for example, a computer similar to that comprising the remote station 24. In one embodiment, the instructor station 30 includes at least one instructor input device (such as a keyboard, touch-screen or the like), and audio input and output devices.

As with the remote station 24, the instructor station 30 is preferably linked at one or more times to the host 22 via a communication link 32. Again, this link 32 may be of a variety of types. In addition, as disclosed below, the host 22 may facilitate communications between the student and the instructor.

The system 20 includes a classroom. In one embodiment, the classroom could be physical, such as comprising the physical location of a instructor table of the instructor station 30. In a preferred embodiment, however, the classroom is virtual and is “created” by the host device 22. As detailed below, the classroom may thus comprise a graphically-represented gaming location, such as a casino game table.

In one embodiment, the system 22 includes a plurality of modules. In one embodiment, these modules comprise a student module 34, an instructor module 36, and an administration module 38. The modules may comprise computer readable code which is configured to implement various system functionality, including functions relating to student activities, instructor, and administration activities. The modules may be configured to present information, such as web pages or other interfaces to users of the system.

In one embodiment, the student module 34 may be configured to implement various functionality. This functionality may include, but is not limited to: (1) registration of a student, such as by establishing a user name and password; (2) effecting payment for services, such as by accepting financial information from a student; (3) providing instruction event schedule information; (4) permitting student enrollment in one or more events; (5) and student participation in an instructional event. As detailed below, the student module 34 may be configured to create or present web pages, web forms, graphical images or the like to a student, as such relates to any or all of the above-detailed activities.

In one embodiment, the instructor module 36 may be configured to implement various functionality. This functionality may include, but is not limited to: (1) registration or enrollment of a instructor; (2) profile creation for a instructor; (3) event scheduling by a instructor; and (4) instructor participation in an instructional event. Once again, the instructor module 36 may be configured to create or present web pages, web forms, graphical images or the like to the instructor, as such relates to any or all of these activities.

In one embodiment, the administration module 38 may be configured to implement various functionality. This functionality may include, but is not limited to: (1) changing system or “administration” settings; (2) setting or altering instructor and event schedules; (3) changing financial rates for event participation; (4) configuration and presentation of virtual classrooms; (5) instructor pay or commission rates for events; (6) number of students per event; (7) number of events (such as the number of events per hour or day, including start and end times); (8) event duration; and (9) participation requirements (such as the minimum time before an event student must enter an event to participate). Once again, the administration module 38 may be configured to create or present web pages or forms, and/or graphical images or the like to the users of the system.

One embodiment of a method of providing casino game instruction will now be described. The method may be implemented using a system such as described above. However, the method may be implemented via other systems and in a variety of other environments.

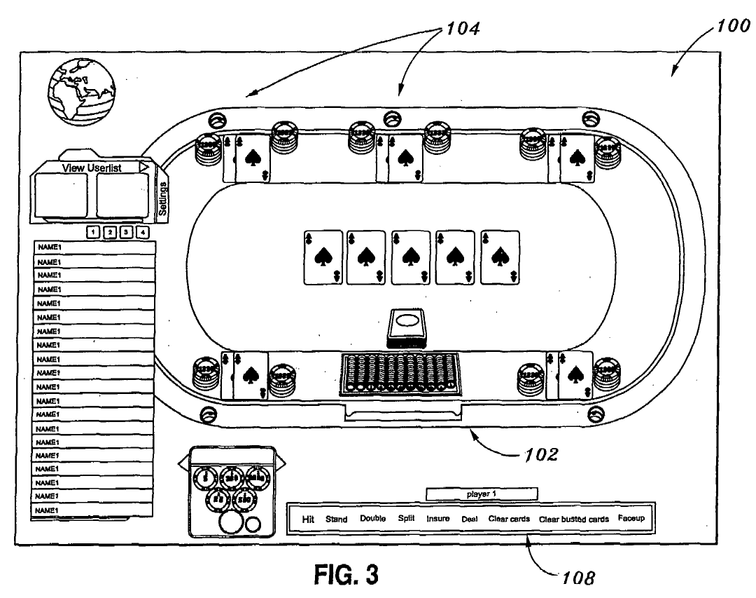

In accordance with one method of the invention, a prospective student enrolls in order to participate in an instructional event. Referring to FIG. 2(a), in one embodiment, a student accesses a website corresponding to the instructional service (though such enrollment could be accomplished manually or in other manners). In reference to the system illustrated in FIG. 1, this may comprise the student utilizing a web browser of a remote station 24 to access the website which is hosted or supported by the host device 22, as in a step S1.

A student may be provided the option to enroll or register. In order to register, the student may be required to provide identifying information, as in a step S2. This information may vary, but may comprise a user name (which may be a real name, coined name, email address and/or other information) and, preferably, a password which is selected by the student. In a preferred embodiment in which a student accesses a website, enrollment information is provided by the student. For example, the student may input information into a web form and that information may then be transmitted to the host device. The information is preferably stored by the host device, such as at a mass storage device associated therewith.

Referring to FIG. 2(a), the student may provide payment, as in a step S3. This may comprise the student providing financial information, such as credit card, bank account or other financial transaction information. The student preferably provides the financial information in order to provide value which may be utilized to pay for goods/services.

A student may utilize the monetary value (provided in step S3) to complete a purchase transaction.

In accordance with the invention, a student may participate in a live casino game instructional event from a remote location. Referring to FIG. 2(b), a student who is enrolled for an event accesses the site, as in a step S1. The student logs in, as in step S2, such as by providing their user name and password. This information is preferably validated against the stored information. Once validated, the student may preferably enter the event, as in a step S3. For example, the student be presented with a list of scheduled events and select their particular event, or may be provided with a list of events for which they are enrolled, as selected from those events.

The instructional event is then presented. In one embodiment, the instructional event is presented once a instructor enters an event and all students who have enrolled have entered. In this regard, students may be prevented from entering an event until a instructor assigned to the event enters the event. Further, students may be provided a cut-off time to enter the event or be barred from participating.

In accordance with the instructional event, a classroom is displayed. As indicated above, the classroom may be a virtual classroom, such as a graphical image or representation of a gaming table (or a photograph of a table or other visual information). The instructor presents a live casino game, allowing the student(s) to participate. One embodiment of a casino game is the game of blackjack.

Importantly, the event is not presented as a wagering event. As such, true wagers are not accepted and winnings are not paid. However, in order to provide instruction regarding how to place wagers, simulated wagers may be placed. For example, before beginning the game, each student may be provided with a number of poker chips. These chips may be graphically represented to the student.

In a preferred configuration, the instructor initiates and controls game presentation, just like a real casino game. Though the actions of the instructor and student(s) may be represented graphically, the casino game is presented live, in the sense that the instructor's and each student's actions are displayed or presented in real time (or near real time, owing to communication transmission and processing time).

In the case of a game of blackjack, the instructor may initiate the game by dealing cards to each student and then themselves. Each student may then view their cards. Students may fold or select additional cards. The game is resolved by the instructor resolving their hand and the comparing their hand to the student's hands. Such actions, if displayed as graphical representations, may be initiated by instructor or student input and effected by the host device. For example, an instructor may select a “deal cards” input which causes the host device to generate card data and graphical card dealing information for display to the students and instructor.

Most importantly, instructional information is presented to the student in association with the acts of game presentation. The instructional information may be presented in a variety of ways. In a preferred embodiment, the instructor speaks instructions or information, which instructions or information are presented to the student. In the case of the system illustrated in FIG. 1, a microphone at the instructor station 30 may receive the instructor's instructions (and convert them to an electrical signal), and those instructions may be disseminated by the speaker(s) of the remote station 24 of the student.

In other embodiments, instructional information may be presented in text format. First an instructor's spoken words may be converted to text and presented graphically. Second, the instructor may type or otherwise input textual information which is then presented graphically.

These instructions may be transmitted from the instructor to the student(s) via the host, or via a separate communication link. For example, audible instructions may be received at the instructor station, transmitted to the host, and disseminated to the student locations.

As indicated above, in the case where the game is presented graphically, the instructor preferably provides inputs which cause game events to occur. For example, the instructor may provide an input which causes graphically represented cards to be dealt to the simulated gaming table. Likewise, the students may provide inputs relating to “player” events. For example, a student may provide an input to a display or keyboard in order to signal their desire to fold or accept one or more additional cards, as part of the instructional game.

In one embodiment, all students who enroll in an event participate in the event as a group. Thus, just like a real casino game which includes a dealer and one or more players, the instructional event involves an instructor and one or more students. Preferably, each student is presented with the same images and thus “see” the same events as all other students. In this manner, each student can see the other student(s) actions, just as though they were sitting at a physical table playing live casino game.

As indicated above, as one aspect of the invention, information may be provided by the instructor to the one or more students. In accordance with the invention, the students are preferably permitted to communicate with the instructor. In one embodiment, students may communicate in one of two modes. In a first or “public” mode, a student's communications are made public, and thus available to all parties in the classroom, including not only the instructor, but other students. In a second or “private” mode, a student's communications are available only to the instructor.

The student may select the mode of communication, such as by input. A student might select a “public chat” or “private chat” button, for example. As with instructor communications, the method of communication may vary. For example, whether the mode is public or private, communications may be aural or visual/textual. A student may speak into their microphone or they may type into a keyboard, for example. Again, such communications may be facilitated by the host. For example, in “public” mode, the host may receive a student communication and then disseminate that communication to the instructor and all other students. In “private” mode, the host may only forward the communication to the instructor.

In accordance with the invention, the instructional game event need not be presented in strict conformity to the rules of casino games. In other words, the instructor may engage in various demonstrations, some of which lead to the completion of a game, and some of which are merely portions or aspects thereof. For example, an instructor might demonstrate to students how to evaluate blackjack hands by dealing several hands without completing those hands or comparing them against the instructor hand.

Once the event or session is complete, the students may be removed from the virtual classroom back to a main or home page of the website, or other location. Alternatively, live activity relating to the classroom may end. For example, the “classroom” may be visible, but without any activity.

The method of presenting casino game instructional events may comprise other activities. As indicated above, such activities may be administrative. In one embodiment, particular users of the system may access administrative functions. Administrative users may be provided with particular authorization. For example, an administrative user may be required to log-in to access administrative functions, or those functions may be accessible automatically by appropriate authorization which is associated with the user's identity.

The administrative user may engage in various functions. For example, the user may change various system settings. In one embodiment, the user may change settings related to one or more instructors (such as their commission or pay), an event or classroom (such as the maximum number of students per event, the duration of an event, time periods for entering an event before being locked out or precluded from participating, the number of events per hour or day or the fee per event), or students (such as student authorizations).

As indicated above, other activities may comprise instructor related activities. An instructor may access the system by logging in (such as by providing a user name and password). An instructor may provide an instructor profile. This may comprise information regarding the instructor which a student may view, such as in making a determination of a particular event to enter. Instructors may be permitted to sign up for events or may be scheduled by the administrator.

As indicated, one aspect of the invention comprises visual information, such as graphical information, which is presented to the instructor and/or student(s). Such information may be presented as part of implementation of a method of the invention.

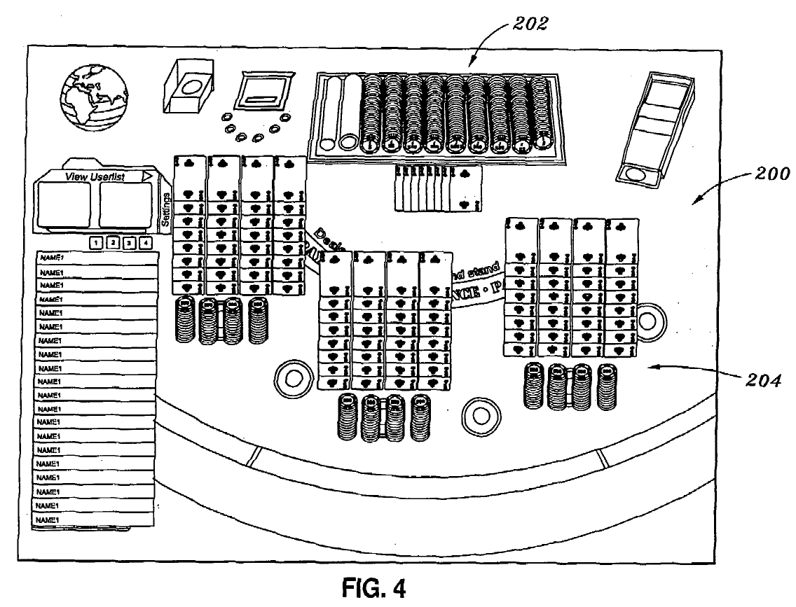

Some particular web pages or “screens” which may be presented to an instructor and/or student are illustrated in FIGS. 3 and 4. FIG. 3 illustrates one example of a “poker classroom.” The classroom is a graphical representation of a poker table 100 having an instructor position 102 and one or more student positions 104. The poker table 100 may have a variety of configurations and include, as illustrated, a visual representation of a surface with a betting line and an exterior rail.

Preferably, images of cards are illustrated in accordance with play/presentation of a gaming event. For example, in the game of poker, a deck of cards may be illustrated. Various cards may be illustrated as being dealt to the student(s), in accordance with the particular poker game which is being demonstrated. Of course, the cards may be illustrated as being dealt face-up or face-down, in accordance with the particular game.

In one embodiment, the classroom may include other information. As illustrated, the classroom may include a list of the names (user names or other identifiers) of the students who are participating in the event. Each student and the instructor may also access other information, such as information about the classroom or the like. This information may vary. In one embodiment, tabs, buttons or other selectable elements may be displayed. When those selectable elements are selected, a signal is transmitted to the host, causing the host to take appropriate action.

The classroom may include the display of other information which is common to all students and the instructor. For example, the classroom may include a “chat window” which displays the text of questions which are presented by other students or answers or instructions from the instructor.

In one embodiment, the classroom may include information which is particular to each student and the instructor. For example, each student may be displayed a wager area 108. This wager area 108 may include one or more selectable elements which allow the student to place an imaginary wager as part of the game demonstration.

Each student may also be presented with a “private chat” window which presents the text of information which is particular to the student. It will also be appreciated that the particular cards or other pertinent game demonstration information which are displayed to each student may vary. For example, a student may be permitted to view their own cards, but not the cards of other students during certain phases of the game demonstration. In this manner, presentation of the game demonstration may emulate a real casino game.

FIG. 4 illustrates one embodiment of a classroom for a blackjack game. Once again, the classroom is illustrated as a graphical representation of a casino table 200. The table 200 has an instructor location 202 and one or more student locations 204. Similar to the classroom for the poker game detailed above, this classroom may be configured to present some information commonly to the instructor and all students, and some information which is unique to the instructor and/or each student. Preferably, the information is presented in a manner which emulates the presentation of a live casino blackjack game.

It will be appreciated that the methods of the invention may be presented with other systems than the system 20 described above. Further, the system 20 may have a variety of configurations and still be configured to present the method(s) of the invention.

In one embodiment, the host device may comprise more than one computing device, those computing devices communicating in a manner enhancing the security of the system. In one embodiment, the host comprises a PHP server with an associated database, and a Flash server. A student may attempt to access the host by sending a login and password over from a Flash player at the remote site to the PHP server. The PHP server processes the login and, if successful (when compared to information in the database), returns ticket to the remote site.

Upon receiving the ticket, the Flash player at the remote site sends a connection request to the Flash server, along with the ticket. The Flash server then communicates with the PHP server (such as via a HTTPS connection), transmitting the ticket back to the PHP server for validation. The PHP server validates the ticket against information regarding the ticket which was stored in the database. If the PHP server validates the ticket, the PHP notifies the Flash server and the Flash server accepts the connection from the remote site. At that point, communications are permitted between the host and the remote site.

In accordance with the system and method, casino game instructions are presented to one or more students. As indicated, the casino game instructions preferably comprise a non-wagering demonstration of one or more casino games.

In a preferred embodiment, the instructor is an actual casino game dealer, such that the instructor can present the casino game instructional event in a manner which emulates a real casino game.

The system and method may be utilized to teach students how to play various casino games. These games include, but are not limited to, poker (in various forms) and blackjack (as detailed above), as well as craps, roulette, baccarat, pai gow, and other casino games now known or later developed.

In one embodiment, instructional information may be presented in various languages. For example, certain events may be presented in English, while other events may be presented in Spanish. In another configuration, the various students to a particular event or session may be permitted to select their particular desired language. A built-in translator may be utilized to convert information from one language to another during an event (for example, an instructor's text instructions may be converted from English to Spanish).

Students may be permitted to communicate with one another. As indicated above, in one embodiment, the names (actual or representative) of each student participating in an event may be displayed. Each student may be permitted to communicate with another student using their name/user name.

A variety of advantages and other features of the method/system will now be appreciated. In accordance with the invention, a student may be provided casino game instructional information at a remote location. Such a remote location might comprise the student's home or office.

In accordance with the invention, students are provided casino game instructions in a live, but remote setting, and in a manner permitting interaction. Thus, a student can not only receive instructional information, but can interact to ask questions and be presented with answers or customized game presentation information. In other words, the content of the instructional session or event can vary each time it is presented, being changed in real time based upon input from the students.

Students and the instructor can communicate during the event. In one embodiment, the parties may transmit text messages. Such messages may be disseminated group-wide, or just to specific parties (private chat). In addition, video or audio information may be transmitted between the parties. For example, aside from a graphical representation of a classroom, video of the instructor may be captured and transmitted to the students. In addition, audio information may be captured and transmitted between the students.

During a session or event, one or more casino games are presented to a student. Preferably, these games are presented as “non-wager” games, meaning that the students are not required to place a wager to participate and are not entitled to winnings for any outcomes of the event. In addition, during the event, other information is preferably disseminated to the students, such as casino game play “etiquette”, “terminology” and other information which is pertinent to knowledgeable play of a real casino game.

As indicated, the casino game need not be presented under strict rules as would a real casino game. Thus, an instructor may present the game in steps and provide instruction regarding each step. The instructor may also repeat various steps or aspects of the presented game.

In one embodiment, a supervisor, such as an administrative user, may view a session or event. The administrator may simply view the session, such as to provide feedback to an instructor at a later time, or may participate in the session, such as by posing questions or answering questions.

In one embodiment, each student may be provided with an event schedule. This schedule may be viewed by the student when they log in to the service. The schedule may identify the times of all events or sessions for which the student is registered.

It will be understood that the above described arrangements of apparatus and the method there from are merely illustrative of applications of the principles of this invention and many other embodiments and modifications may be made without departing from the spirit and scope of the invention as defined in the claims.

What is claimed is:

1. A casino game instructional system comprising:
a host server, said host server including a first communication port for establishing a first communication link between said host server and an instructor location over which information may be transmitted and a second communication port for establishing a second communication link between said host server and at least one student location over which information may be transmitted, said host server configured to generate information regarding a virtual classroom including graphical information regarding a casino-game instructional event and transmit audio and video information between an instructor providing instructional information at said instructor location and a student at said student location, in real time.

2. The casino game instructional system in accordance with claim 1 wherein at least a portion of said second communication link comprises the world wide web.

3. The casino game instructional system in accordance with claim 1 wherein said virtual classroom information comprises a web page displaying at least a portion of a casino table.

4. The casino game instructional system in accordance with claim 1 wherein a student module, an instructor module and an administrator module are associated with said host server.

5. The casino game instructional system in accordance with claim 1 wherein said host server is configured to permit private communication between said student location and said instructor location or public communication between said student location and said instructor location.

6. The casino game instructional system in accordance with claim 1 wherein said at least one student location comprises a remote computing device.

7. The casino game instructional system in accordance with claim 1 wherein said instructor location comprises a remote computing device.

8. A method of providing instructions regarding casino game play comprising:
establishing a communication link between a host and at least one student location establishing a communication link between said host and an instructor location;
transmitting virtual classroom information from said host to said at least one student location and said instructor location;
receiving audible instruction information from said instructor location;
transmitting said audible instruction information to said at least one student location; and
displaying game play information in association with said virtual classroom.

9. The method in accordance with claim 8 including the step of transmitting a message from said student location to said instructor location.

10. The method in accordance with claim 9 wherein said message comprises a question regarding said casino game.

11. The method in accordance with claim 9 wherein a communication link is established with a plurality of student locations and said student information is transmitted to said instructor location and all other student locations.

12. The method in accordance with claim 9 wherein a communication link is established with a plurality of student locations and said student information is transmitted only to said instructor location and no other student location.

13. The method in accordance with claim 8 wherein said game play information includes the display of card indicia.

14. The method in accordance with claim 8 wherein said step of establishing a communication link between said at least one student location and said host comprises providing a host website and allowing a student to access said website over a communication link comprising the world wide web.

15. A method for providing casino game instruction, comprising the steps of:
providing a host server;
establishing a first communication link between an instruction location and said host server;
establishing a second communication link between a student location and said host server;
linking said first communication link and said second communication link through said host server; transmitting audible casino game instructions from an instructor at said instructor location to said student location;
transmitting virtual classroom information from said host to said student and instructor locations; and
displaying game play information in association with said virtual classroom information.

16. The method in accordance with claim 15 wherein said virtual classroom information comprises a graphical image of a casino table.

17. The method in accordance with claim 15 including the step of receiving a message from said student location at said host and forwarding said message from said student location to said instructor location.

18. The method in accordance with claim 17 including the step of establishing at least one third communication link with one or more additional student locations and transmitting said message from said student location to said one or more additional student locations.
